(19) United States
(12) Patent Application Publication
(10) Pub. No.: US 2012/0313856 A1
(43) Pub. Date: Dec. 13, 2012

(54) KEYBOARD PROVIDING SELF-DETECTION OF LINKAGE

(76) Inventor: Yu-Chun Hsieh, New Taipei City (TW)

(21) Appl. No.: 13/156,812

(22) Filed: Jun. 9, 2011

(51) Int. Cl. G06F 3/02

(52) U.S. Cl. 345/168

(57) ABSTRACT

A keyboard providing self-detection of linkage includes a key set module, a circuit unit, a wired transmission interface electrically connected to the circuit unit, a wireless transmission interface electrically connected to the circuit unit, and a micro-control unit electrically connected to the circuit unit. The key set module includes a plurality of keys depressible by users to trigger the circuit unit to generate a message signal. The micro-control unit detects an electrical connection signal generated by electrical connection between a transmission cable and the wired transmission interface, and transmits the message signal to the wired transmission interface upon detecting presence of the electrical connection signal, or sends the message signal to the wireless transmission interface when no electrical connection signal is detected. Thus the keyboard is equipped with both the wired transmission interface and wireless transmission interface at the same time.

### FIELD OF THE INVENTION

The present invention relates to a keyboard providing self-detection of linkage and particularly to a keyboard equipped with both wireless and wired transmission interfaces and capable of selecting the transmission interface by itself.

### BACKGROUND OF THE INVENTION

Keyboard is an important device for communication between people and technology, and commonly used as a communication interface with computers or other digital devices. With progress of technology, different types of linkage have been developed to the keyboard.

Initially linkage between the keyboard and computer adopted a communication interface standard of RS-232/DB-9, then advanced to PS/2 communication interface, and finally has progressed to USB communication interface now with greatest compatibility, which adopts wired connection. However, as applications of computers and digital devices have gradually personalized and entered into people's daily life, application environments are no longer limited to office desks or computer tables. Naturally linkage between the keyboard and computers or digital devices also evolves from the wired connection within a limited distance to wireless connection within a wider area.

To meet wireless transmission requirement on the keyboard, infrared transmission technique was first widely adopted. However, infrared transmission is directional and a smooth high speed connection of the infrared transmission often is limited to a short distance within few meters and obstacles therebetween. Hence these cause strict limitations on use angles and distance of the wireless keyboard. As a result, infrared-enabled keyboard is not well received by most users and has gradually faded out from the market.

In recent years, plenty of electronic industries have set up a common wireless communication standard of Bluetooth communication technology. It not only increases the linking distance, but also overcomes use angle problem and provides greater compatibility. Aside from being adopted on mobile communication field, it also has been expanded to keyboard, mouse and game machine fields.

However, take the Bluetooth keyboard to be used as an input device, the system (such as computer or mobile phone) receiving Bluetooth keyboard signals must have a Bluetooth transmission module to establish a linkage with the Bluetooth keyboard. But the Bluetooth transmission module is not yet a built-in device in the general computer. Hence even if a user carries a Bluetooth keyboard, it does not mean the Bluetooth keyboard can establish a linkage with any devices whenever desired. This causes use limitation.

### SUMMARY OF THE INVENTION

In view of the conventional Bluetooth transmission module that is not built in the computer to make direct connection between a Bluetooth keyboard and most computer systems impossible and result in use limitation, the primary object of the present invention is to provide an improved keyboard equipped with both a wireless transmission interface and a wired transmission interface at the same time, and a control circuit in the keyboard to determine the priority of the interfaces to be used to improve usability.

The present invention aims to provide a keyboard capable of detecting linkage by itself. The keyboard includes a key set module, a circuit unit, a wired transmission interface electrically connected to the circuit unit, a wireless transmission interface electrically connected to the circuit unit, and a micro-control unit electrically connected to the circuit unit. The key set module includes a plurality of keys depressible by users to trigger the circuit unit to generate a message signal. The micro-control unit detects an electrical connection signal generated by electrical connection between a transmission cable and the wired transmission interface, and sends the message signal at a first priority to the wired transmission interface upon detecting presence of the electrical connection signal, or sends the message signal to the wireless transmission interface when it does not detect the electrical connection signal.

By means of the technique set forth above, the keyboard provides both the wired transmission interface and wireless transmission interface simultaneously. Through the self-detection and self-judgment of the micro-control unit, the keyboard can be connected to a computer or handset in the most convenient way by users without setting or switching connection, hence greatly improves usability.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of an embodiment of the invention.

FIG. 2 is a schematic view of an embodiment of the keyboard of the invention.

FIG. 3 is a circuit block diagram of another embodiment of the invention.

### DETAILED DESCRIPTION OF THE PREFERRED EMBODIMENTS

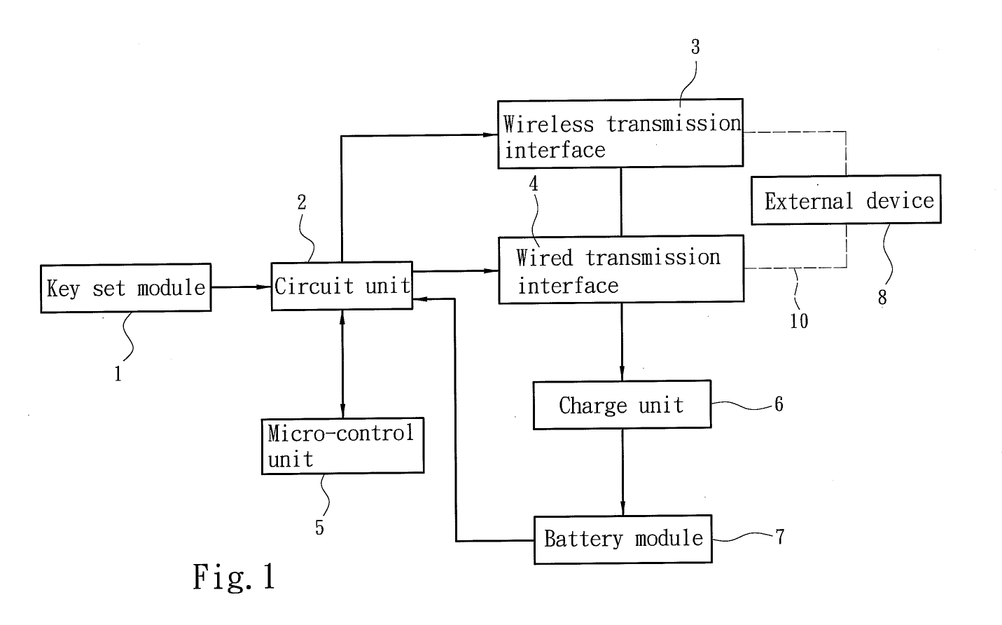

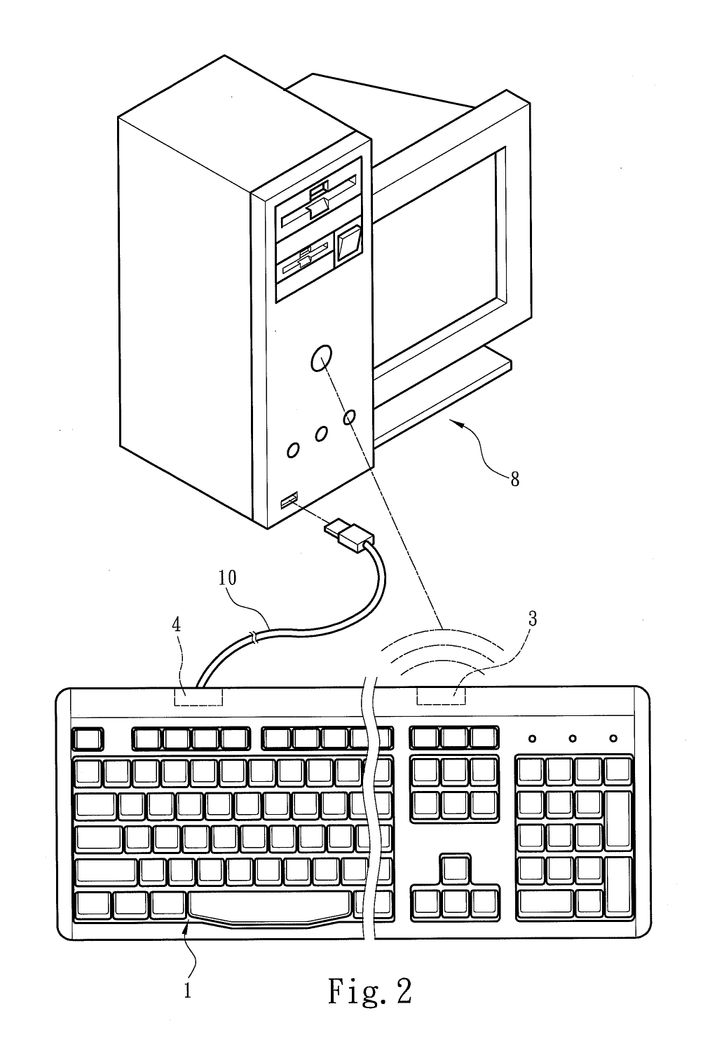

The present invention aims to provide a keyboard capable of detecting linkage by itself. Please refer to FIGS. 1 and 2, the keyboard of the invention includes a key set module 1 and a circuit unit 2. The key set module 1 includes a plurality of keys installed on a keyboard housing. The circuit unit 2 is located in the keyboard housing. The keys are depressible to trigger the circuit unit 2 to generate a message signal. The structure and principle of the keyboard housing and key movements are known in the art, thus are not marked in the drawings and details thereof also are omitted herein. The circuit unit 2 is electrically connected to a micro-control unit 5 which can be an integrated circuit directly connected to the circuit unit 2. The micro-control unit 5 can perform signal format conversion. The keyboard further includes a wireless transmission interface 3 and a wired transmission interface 4 that are electrically connected to the circuit unit 2. The wired transmission interface 4 also is electrically connected to a transmission cable 10 through which the keyboard can transmit signals back and forth with an external device 8. The wireless transmission interface 3 can transmit signals back and forth through a wireless transmission technology with the external device 8 which supports the same wireless transmission technology. The aforesaid wireless transmission interface 3 is preferably a Bluetooth transmission module. The wired transmission interface 4 can be a USB transmission interface or a SATA transmission interface. Thus the keyboard is equipped with two types of interfaces at the same time and capable of transmitting signals with the external device 8. When the external device 8 is electrically connected to the wired transmission interface 4 via the transmission cable 10, an electrical connection signal is generated to show that a linkage has been established with the external device 8. The wired transmission interface 4 receives the electrical connection signal and sends to the circuit unit 2. Furthermore, the micro-control unit 5 is set to be electrically connected to the circuit unit 2 to detect the electrical connection signal generated by electrical connection between the transmission cable 10 and the wired transmission interface 4. The micro-control unit 5 determines whether to activate the wireless transmission interface 3 or wired transmission interface 4 by detecting whether the electrical connection signal is generated. More specifically, when the micro-control unit 5 detects the presence of the electrical connection signal, it sends the message signal generated by the circuit unit 2 to the wired transmission interface 4 at a first priority. When the micro-control unit 5 does not detect the electrical connection signal, it sends the message signal generated by the circuit unit 2 to the wireless transmission interface 3. In other words, when the external device 8 is connected to the wired transmission interface 4 via the transmission cable 10, the keyboard actively selects the wired transmission interface 4 to output. When the keyboard cannot establish connection with the external device 8 through the wired transmission interface 4, the wireless transmission interface 3 is activated to detect the external device 8 capable of supporting wireless transmission to establish linkage.

Moreover, when the keyboard is connected to the external device 8 through the wireless transmission interface 3, it requires self-contained power supply to support operation of circuit elements in the keyboard. Hence the keyboard further includes a charge unit 6 electrically connected to the wired transmission interface 4. When the wired transmission interface 4 is connected to the external device 8, the wired transmission interface 4 gets external power to supply to the charge unit 6 which then charges a battery module 7 built in the keyboard. The battery module 7 is electrically connected to the circuit unit 2 to supply electric power for operation of the keyboard when the wireless transmission interface 3 is activated.

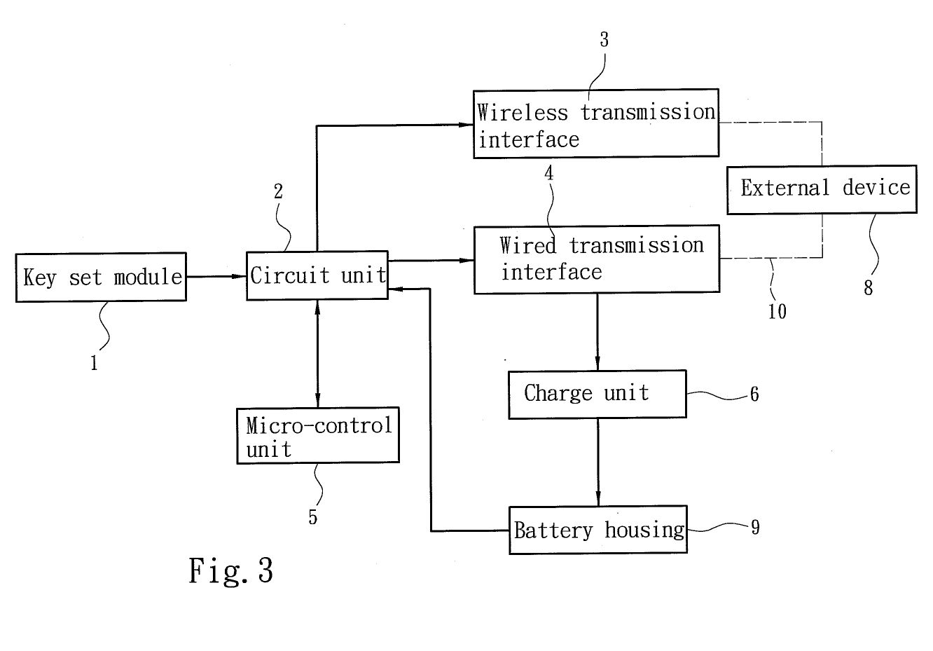

Referring to FIG. 3, the keyboard can also include a battery housing 9 electrically connected to the circuit unit 2. The charge unit 6 is electrically connected to the battery housing 9 which holds replaceable batteries available on the market. The batteries also supply power for normal operation when the wireless transmission interface 3 is activated.

While the invention has been described by means of specific embodiments, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A keyboard providing self-detection of linkage, comprising:
a key set module including a plurality of keys depressible by users;
a circuit unit triggered by depression of the keys to generate a message signal;
a wired transmission interface electrically connected to the circuit unit and a transmission cable to output;
a wireless transmission interface electrically connected to the circuit unit; and
a micro-control unit which is electrically connected to the circuit unit and detects an electrical connection signal generated by electrical connection between the transmission cable and the wired transmission interface; wherein when the micro-control unit detects presence of the electrical connection signal, it sends the message signal to the wired transmission interface at a first priority; wherein when the micro-control unit does not detect the presence of the electrical connection signal, it sends the message signal to the wireless transmission interface.

2. The keyboard of claim 1, wherein the wireless transmission interface is a Bluetooth transmission module.

3. The keyboard of claim 1, wherein the wired transmission interface is a USB transmission interface.

4. The keyboard of claim 1, wherein the wired transmission interface is a SATA transmission interface.

5. The keyboard of claim 1, wherein the micro-control unit is located on the circuit unit.

6. The keyboard of claim 1 further including a charge unit electrically connected to the wired transmission interface which receives external power through the transmission cable to supply to the charge unit.

7. The keyboard of claim 6 further including a battery module built therein and electrically connected to the charge unit.

8. The keyboard of claim 6 further including a battery housing which is electrically connected to the charge unit and holds at least one battery.
